(19) United States
(12) Patent Application Publication
(10) Pub. No.: US 2009/0095808 A1
(43) Pub. Date: Apr. 16, 2009

(54) METHOD FOR MANUFACTURING A PORTABLE PAYMENT TERMINAL, CORRESPONDING TERMINAL, DEVICE AND BATTERY

(75) Inventor: David Naccache, Paris (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Compagnie Financiere Et Industrielle D'Ingenierie "Ingenico", Neuilly Sur Seine (FR)

(21) Appl. No.: 12/249,599

(22) Filed: Oct. 10, 2008

(30) Foreign Application Priority Data
Oct. 12, 2007 (FR) 07/58296

(51) Int. Cl. G06K 5/00; H01M 2/06

(52) U.S. Cl. 235/380; 29/592.1; 29/729; 429/163

(57) ABSTRACT

A method is provided for manufacturing a payment terminal. The method includes: obtaining a dedicated battery with a predetermined complex shape adapted for cooperating with the shape of at least one other adjacent component of said terminal; and assembling the components of said terminal, including positioning said battery in an imbricated way with said adjacent component(s).

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates to credit card payment terminals, and more precisely portable or mobile payment terminals. Such terminals particularly comprise a chip card reader, a keypad and a display. They are mobile, and therefore powered with cells or batteries and connected or connectable to a transfer unit to bank entities, for example via a supporting base.

In the following description, the term “battery” is used to refer to a battery or a battery set required for the running of a payment terminal.

The disclosure relates more precisely to the optimisation of the size and manufacturing of such terminals.

### BACKGROUND OF THE DISCLOSURE

The existing terminals implement extractable and standardised batteries, which introduces limitations on the size and particularly on the shape of these batteries, which generally have a parallelepiped or cylinder shape.

Besides, these batteries are replaceable, and thus removable. Current terminals have a compartment with an opening for accessing one or more batteries in order to replace them, and therefore have a removable door and means for inserting, removing and connecting the batteries. The design of these terminals should therefore provide a large and easily accessible space for these batteries.

FIGS. 1a and 1b illustrate an exemplary casing of such a payment terminal according to the prior art.

FIG. 1a shows an outside view of the top of a casing 10 of a payment terminal, the dimensions thereof being L1 for the length (for example about 200 mm), h1 for the thickness (for example about 60 mm) and l1 for the width (for example about 95 mm).

FIG. 1b shows an outside view of the bottom of the same casing 10, with a compartment 11 for the extractible battery 12.

It is found that the battery has a shape corresponding to the location in the compartment provided in the casing.

The drawbacks of the prior art techniques are that because of the current battery shapes and because it is necessary to make them accessible, the terminal size and manufacturing (component implantation, organisation and assembly thereof, . . . ) are strongly limited. It should be noted that these drawbacks have never been identified as such since they correspond to limitation considered as imperative by the person skilled in the art. Therefore, the definition of such drawbacks, that is the identification, which has never been made in this field, of a problem to solve, is per se, part of the invention.

### SUMMARY

An aspect of the present disclosure a method for manufacturing a payment terminal.

According to an aspect of the disclosure, said method comprises the steps of:
obtaining a dedicated battery, with a predetermined complex shape adapted for cooperating with the shape of at least one other adjacent component of said terminal;
assembling components of said terminal, including positioning said battery imbricated with said adjacent component(s);
inserting said assembly inside a permanently closed casing, without any access lid to said battery.

In accordance, an aspect of the present disclosure is based on a novel and inventive approach of the manufacturing of a payment terminal, wherein access means to a battery are not provided, and the battery position is optimised between the components. In other words, while in the prior art, the design and manufacturing are particularly made according to the batteries and their housing, an aspect of the disclosure suggests an opposite approach: the batteries are no longer a manufacturing constraint, but on the contrary, their positions are optimised according to the available space left by the components.

In accordance, the method according to an aspect of the disclosure first comprises a step of obtaining a battery with a predetermined shape, particularly based on the arrangement of the different elements composing the terminal. In particular, the battery has a shape which adapts to the component(s) around it in the terminal. The shape of these batteries may be complex, as a function of the available space limitations.

Then, the method according to an aspect of the disclosure comprises a step of assembling the different elements, particularly the battery, so that it imbricates with the surrounding component(s).

According to a particular feature of an aspect of the disclosure, the manufacturing method comprises a step of inserting said assembly in a casing which is permanently closed, without any access lid to said battery.

Therefore, once all the elements composing the terminal are assembled, they are inserted in a closed casing, avoiding the need for removal means or an access door.

In particular, the shape of said battery is defined so as to occupy, at least partly, at least one free complex space in said payment terminal.

A complex space means a space with a non elementary shape, different from a parallelepipe or cylinder. It may be, for example, a combination of several parallelepipeds of different sizes. Examples are shown below in the description, in relation with FIGS. 3 and 4.

Therefore, the space occupied by the components in the terminal is optimised, and the battery is not required to observe particular limitations, for example, the need for the battery to be extractable. The battery is considered as any other component for arranging the internal space of the terminal.

The optimisation of the internal space of the terminal may be further improved, for example, first by arranging all the components other than the battery in the internal space of the terminal, and by defining a battery shape occupying a space still available, even if this space has a complex shape.

According to a particular embodiment, said step of obtaining and said step of assembling the manufacturing method take place simultaneously and comprise a step of moulding said battery in said identified free space.

Therefore, the battery is not manufactured before assembling the components of the terminal, but upon this assembling, in a step of moulding the battery in the free space inside the terminal, which has been previously identified for receiving the battery.

Another aspect of the disclosure relates to a payment terminal comprising a set of components, among which a battery and at least an adjacent component of said battery.

According to an aspect of the disclosure, said battery is a dedicated battery with a predetermined complex shape adapted to cooperate with the shape of at least one other adjacent component of said terminal, said battery being imbricated with said adjacent component(s).

In particular, said components are housed in a permanently closed casing, without any access lid to said battery.

According to an aspect of the disclosure, the terminal thus comprises a closed casing, without any access door, incorporating all these components, including a battery, having a shape allowing the internal space and thus the size thereof to be optimised.

An aspect of the disclosure also relates to a device for manufacturing a payment terminal.

According to an aspect of the disclosure, such a device comprises means for assembling the components of said terminal, comprising means for positioning a dedicated battery, imbricated with at least one adjacent component, said dedicated battery having a predetermined complex shape adapted to cooperate with the shape of said adjacent component(s).

Such a device for manufacturing a terminal is particularly suitable for implementing the method for manufacturing a terminal as described above.

An aspect of the disclosure relates, lastly, to a battery for a payment terminal comprising a set of components, among which a battery and at least one adjacent component of said battery.

According to an aspect of the disclosure, such a battery has a predetermined complex shape adapted for cooperating with the shape of at least one other adjacent component of said terminal, said battery being imbricated with said adjacent component(s).

### BRIEF DESCRIPTION OF THE DRAWINGS

Others features and advantages of the disclosure will appear more clearly with the following description of a particular embodiment, given as a simple illustrative and non limitative example, and attached drawings, in which:

FIGS. 1a and 1b respectively show an outside view of the topside and an outside view of the bottom of an exemplary payment terminal casing according to the prior art;

FIG. 2 shows an exemplary payment terminal casing (outside view) according to an aspect of the disclosure;

FIGS. 3 and 4 show two exemplary internal arrangements of a payment terminal according to an aspect of the disclosure;

FIG. 5 describes the major steps of the method for manufacturing a payment terminal according to an aspect of the disclosure.

### DETAILED DESCRIPTION OF ILLUSTRATIVE EMBODIMENTS

The general principle of an aspect of the disclosure is the use of a non extractable battery and therefore, that the arrangement of components inside the casing of a terminal can be carried out without the limitations related to the requested extractability of the battery.

In accordance, the manufacturing method according to an aspect of the disclosure is based on the identification of a battery location, among the other components of the terminal, in order to design a battery shape adapted to this location.

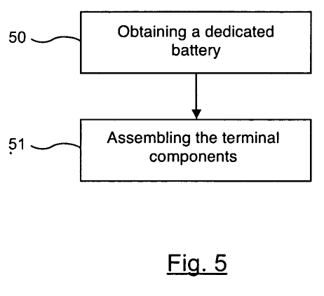

In relation with FIG. 5, the different steps of the manufacturing method according to an aspect of the disclosure are presented below.

Step 50 of obtaining a dedicated battery therefore includes manufacturing a battery with a dedicated, potentially complex, shape (the design thereof takes into account the available space between the different components of the terminal), that is corresponding to a location with a complex shape.

In accordance, upon designing, all the components of the terminal, except the battery, are first arranged in an optimal way, that is by trying to minimise the final size of the terminal. A housing and an access to be provided for a conventional battery are not taken into account, a priori.

Such an arrangement leaves one or more free spaces inside the terminal casing because of the different shapes and sizes of the components. Then, a battery shape able to be adapted to one or more of the free spaces is defined.

The shape of the battery may also be defined during the arrangement of the other terminal components. For example, the different terminal components, except the battery, are arranged one by one and on each incorporation of a new component, it is assessed whether the incorporation of the particular shape of battery allows an arrangement of the remaining components to be optimised. If so, the location thus determined for the battery is left empty, and the arrangement of other components is carried on.

Once the battery is manufactured, it is incorporated with the other components during the assembling step 51. Therefore, according to an aspect of the disclosure, the battery is imbricated between different other elements, which allows the space to be used in an optimal way.

According to a particular an aspect of the disclosure, the steps of obtaining a battery and assembling the components are simultaneous and manufacturing the battery actually corresponds to moulding the battery into the predefined location, which corresponds to a space left free by the other components.

FIG. 2 shows an outside view of a payment terminal 20 made according to the manufacturing process of an aspect of the disclosure, the dimensions thereof being L2 for the length, h2 for the thickness and l2 for the width.

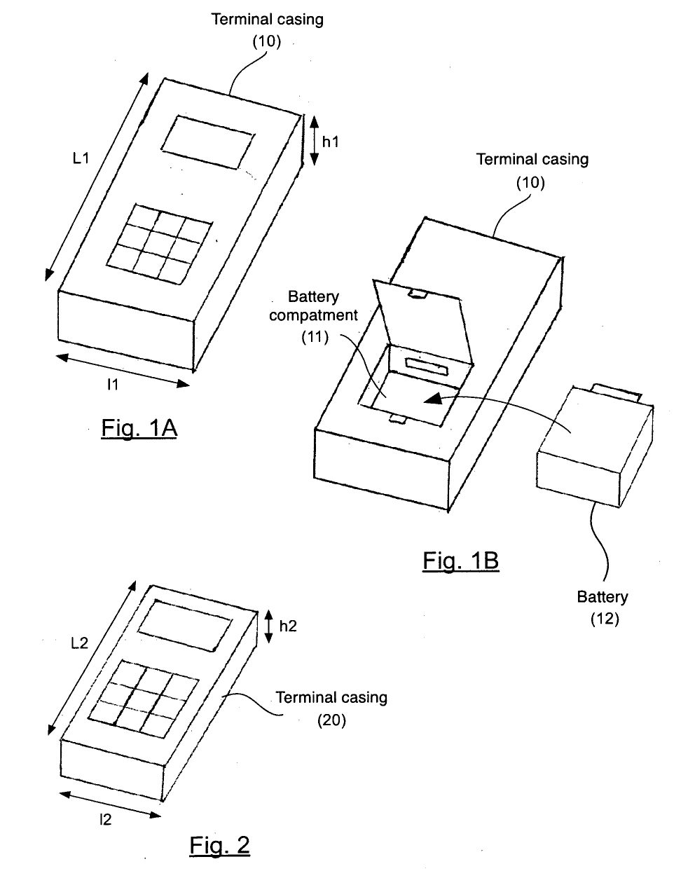

It is assumed that the internal components, except the battery, are the same as for the prior art terminal example of FIG. 1, and it is noted that L2<L1, h2<h1 and l2<l1. Length L2 may, for example, be less than 190 mm (about 200 mm for L1), height h2 may be less than 50 mm (about 60 mm for h1) and width l2 may be less than 90 mm (about 95 mm for l1).

Therefore, the method according to an aspect of the disclosure allows the outside dimensions of a payment terminal to be reduced, by arranging in an optimal way the inside components.

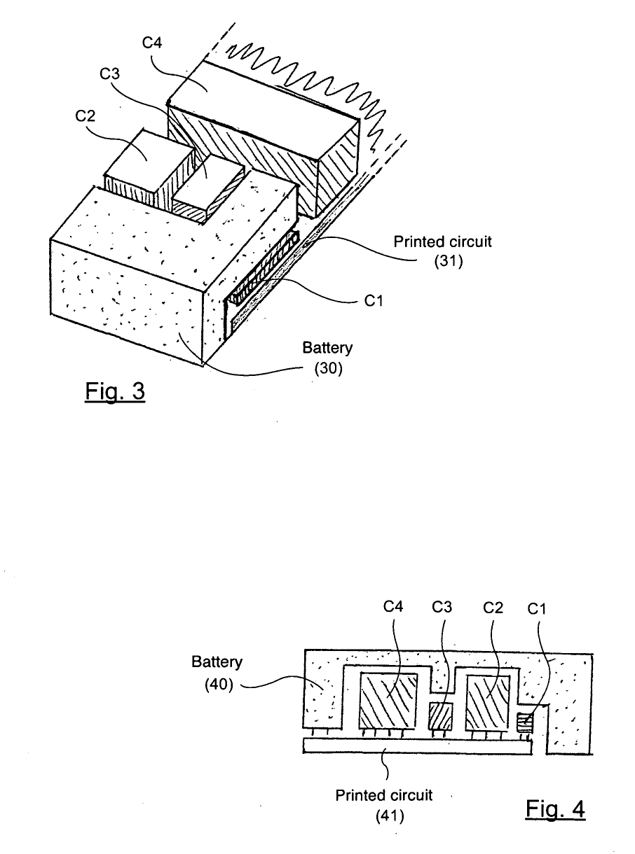

In relation to FIGS. 3 and 4, two exemplary arrangements of the components inside a payment terminal carried out according to the manufacturing method of an aspect of the disclosure will now be shown.

In these two examples, the components shown C1, C2, C3 and C4 are elements making up the terminal, having varying and exemplary dimensions and locations. It is assumed that these components are located in their respective locations as a function of various manufacturing limitations or requirements. They may particularly be electronic components, mounted to a printed circuit 31 or 41, but also any other requested elements in such a terminal (chip card reader, keypad, display, printer . . . ).

The shapes and dimensions of these components define free spaces to be used by the battery according to an aspect of the disclosure.

In these two figures, the battery actually has a complex shape, adapted to other components in order to optimise the internal space of the terminal.

In accordance, in FIG. 3, the battery is compact and imbricates above the component C1 and near the components C2 and C3.

In FIG. 4, the battery is fitted above different components C1, C2, C3 and C4. In that case, the battery may also serve as a bottom for the casing. In other words, the battery may take part in the casing function and as such, further reduce the overall dimensions and/or make the mounting easier.

According to other manufacturing aspects, the battery may also serve as a partition between two components, instead of a specific wall. The battery may also serve as a protection for a brittle component, for example, again instead of a specific protection. It may also serve as a guide for assembling the components, even for defining a receptacle for any of these components.

Therefore, the method according to an aspect of the disclosure allows the battery to be given one or more other functions than its original function as a power supply.

An aspect of the present disclosure thus optimises the size and (internal and/or external) organisation of payment terminals.

An aspect of the present disclosure thus provides a technique allowing payment terminals having various shapes and a reduced size to be provided.

An aspect of the present disclosure provides a technique allowing the organisation and the density in a payment terminal to be improved, particularly by optimising the occupied internal space.

An aspect of the present disclosure provides a technique which can be easily implemented and inexpensive.

Although the present disclosure has been described with reference to one or more examples, workers skilled in the art will recognize that changes may be made in form and detail without departing from the scope of the disclosure and/or the appended claims.

1. A method for manufacturing a payment terminal, the method comprising:
obtaining a dedicated battery, with a predetermined complex shape adapted for cooperating with the shape of at least one other adjacent component of said terminal;
assembling components of said terminal, including positioning said battery imbricated with said at least one adjacent component;
inserting said assembly inside a permanently closed casing, without any access lid to said battery.

2. The method according to claim 1, wherein said battery shape is defined so as to occupy, at least partly, at least one free complex space inside said payment terminal.

3. The method according to claim 1, wherein said obtaining step and said assembling step are simultaneous and include a step of moulding said battery inside said identified free space.

4. A payment terminal comprising a set of components, including a battery and at least one adjacent component of said battery, wherein said battery is a dedicated battery with predetermined complex shape adapted cooperate with the shape of at least one other adjacent component of said terminal, said battery being imbricated with at least one said adjacent component and said components are housed inside a permanently closed casing, without any access lid to said battery.

5. A device for manufacturing a payment terminal, wherein the device comprises means for assembling said terminal components, comprising:
means for positioning a dedicated battery, imbricated with at least one adjacent component, said dedicated battery having a predetermined complex shape adapted for cooperating with the shape of said at least one adjacent component, and
means for inserting said component assembly of said terminal inside a permanently closed casing, without any access lid to said battery.

6. A battery for a payment terminal comprising a set of components, including a battery and at least one adjacent component of said battery, wherein the battery has a predetermined complex shape adapted to cooperate with the shape of at least one other adjacent component of said terminal, said battery being imbricated with said at least one adjacent component.
